(19) United States
(12) Patent Application Publication
(10) Pub. No.: US 2012/0060769 A1
(43) Pub. Date: Mar. 15, 2012

(54) NESTABLE PET STEP

(75) Inventor: Adam Weber, Keller, TX (US)

(73) Assignee: DOSKOCIL MANUFACTURING COMPANY, INC., Arlington, TX (US)

(21) Appl. No.: 13/230,515

(22) Filed: Sep. 12, 2011

Related U.S. Application Data
(60) Provisional application No. 61/382,183, filed on Sep. 13, 2010.

(51) Int. Cl. A01K 29/00; B23P 11/00

(52) U.S. Cl. 119/847; 29/428

(57) ABSTRACT

Embodiments disclosed herein relate to a pet step including one or more steps. The pet step may further include a base portion configured to rest on a generally flat surface and support the one or more steps. The base portion may include first, second, third, and fourth sidewalls, where the first and second sidewalls define triangular-shaped apertures. In some embodiments, multiple pet steps may be nested or stacked atop one another.

### CROSS-REFERENCE TO RELATED APPLICATIONS

The present application is related to, and claims priority to, U.S. Provisional Patent Application No. 61/382,183, filed Sep. 13, 2010, entitled, “Nestable Pet Step,” which is incorporated herein by reference in its entirety and for all purposes.

### FIELD

Embodiments described herein relate to pet care products, and more specifically to nestable steps for pets.

### BACKGROUND ART

Many pets have difficulty reaching different elevations. For example, pets that are recovering from surgery or suffering from arthritic conditions may experience discomfort or pain when climbing or jumping to elevated areas. As another example, smaller pets may be unable to reach elevations that are too high relative to their height. Some pet owners may use pet steps or ramps to allow their pets to reach elevated areas. Such products may allow unsupervised pets to access such elevations independently, for example, when the owner is at work or otherwise not available to help the animal.

Existing pet steps and ramps are often bulky and heavy, and therefore cannot be easily transported. Existing pet steps and ramps also have the problem of collapsing under the weight of an animal ascending or descending the steps or ramp.

### SUMMARY

Embodiments disclosed herein may include pet steps for defining one or more stairs and a base portion for supporting the weight of an animal traversing the stairs. The pet steps may distribute the weight of an animal in both diagonal and vertical directions, thereby preventing collapse of the steps under the weight of the animal. Multiple pet steps may be nestable or stackable atop one another.

One embodiment takes the form of a pet step including one or more steps. The pet step may further include a base portion configured to rest on a resting surface and support the one or more steps. The base portion may include first, second, third, and fourth sidewalls, where the first and second sidewalls define triangular-shaped apertures. In some embodiments, multiple pet steps may be nested or stacked atop one another.

Another embodiment takes the form of a pet step configured to rest on a surface. The one or more steps have gradually decreasing widths from a bottom end to a top end of the pet step. The pet step may further include a base portion configured to rest on the surface and support the one or more steps. The base portion may include first, second, third, and fourth sidewalls, with the first sidewall being generally parallel to and opposite the second sidewall, and the third sidewall being generally parallel to and opposite the forth sidewall. The base portion may have a width that is larger than at least one of the widths of the one or more steps and may be configured to distribute compressive forces exerted on the one or more steps in a diagonal direction.

Another embodiment may take the form of a method for manufacturing a pet step. The method may include forming a base portion including first, second, third, and fourth walls that extend in a generally upward direction from a resting surface to a ceiling defining one or more steps. The first wall may be generally parallel to and opposite the second wall and the third wall may be generally parallel to and opposite the fourth wall. The method may further include defining a first triangular-shaped aperture in the first wall and defining a second triangular-shaped aperture in the second wall.

These and other objects and advantages of the disclosed embodiments will become readily apparent from the following detailed description taken in conjunction with the accompanying drawings.

### BRIEF DESCRIPTION OF THE FIGURES

FIG. 1A illustrates a front view of a first embodiment of a pet step.

FIG. 1B illustrates a front perspective view of the embodiment of FIG. 1A.

FIG. 1C illustrates a side view of the embodiment of FIG. 1A.

FIG. 1D illustrates a rear view of the embodiment of FIG. 1A

FIG. 2 illustrates a side view of multiple stacked pet steps.

FIG. 3 illustrates a front perspective view of a second embodiment of a pet ramp.

FIG. 4 is a flow diagram illustrating a method for manufacturing a pet step.

### DETAILED DESCRIPTION

Embodiments disclosed herein may include pet steps for defining one or more stairs and a base portion for supporting the weight of an animal traversing the stairs. Two opposing sidewalls of the pet steps may include apertures, which allow for distribution of the weight of an animal in both diagonal and vertical directions, thereby preventing collapse of the steps under the weight of the animal. Multiple pet steps may be nestable or stackable atop one another. Another embodiment may include a pet ramp configured to distribute weight in both diagonal and vertical directions.

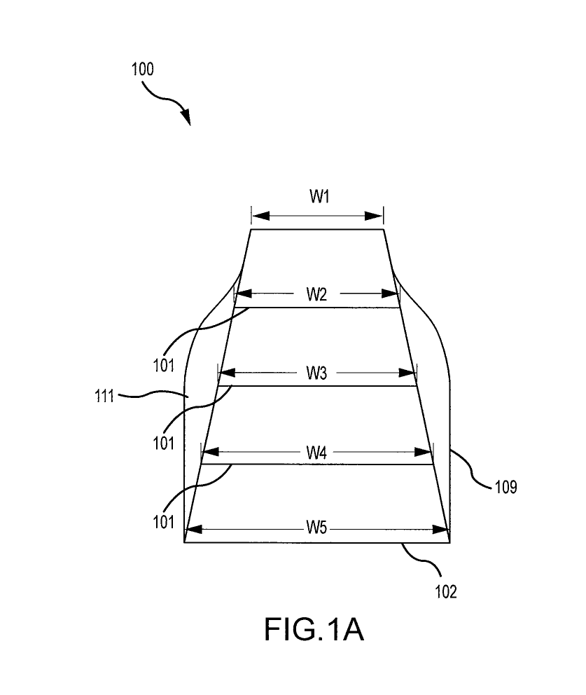

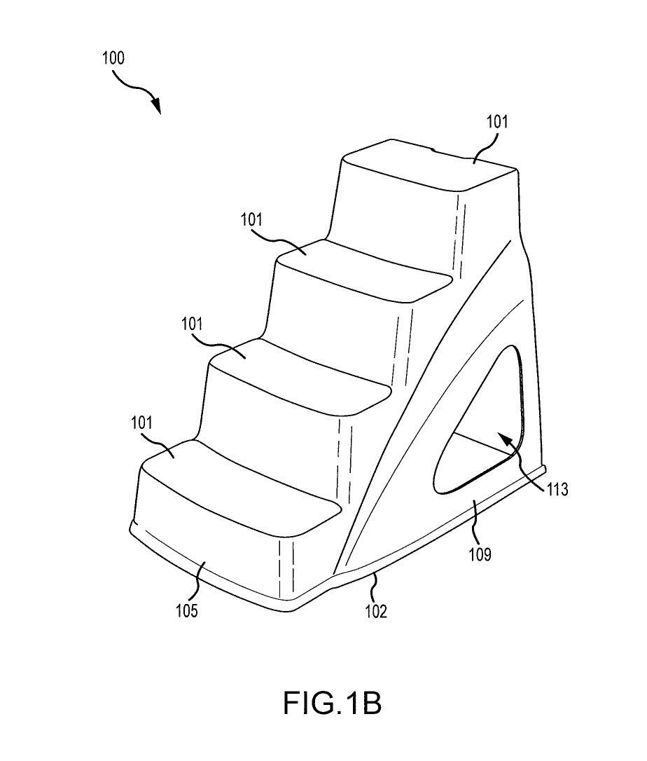

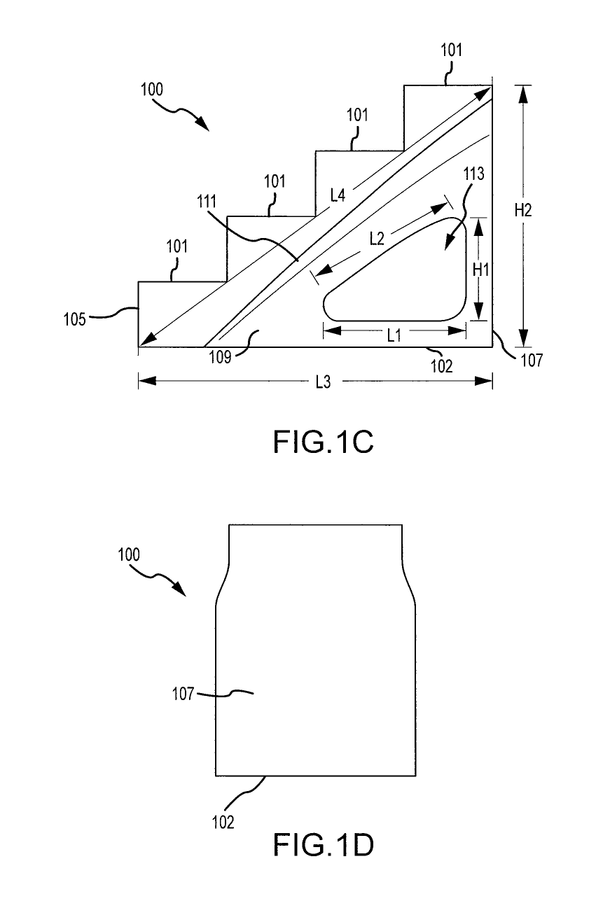

Referring now to FIGS. 1A-1D, the pet steps 100 may include one or more steps 101 supported by a base portion 103. The base portion 103 may be configured to support and stabilize the pet steps 103 when rested on a generally flat surface, such as a floor, or other surface. In one embodiment, the base portion 103 may include a bottom edge 102 that is configured to contact the resting surface. In other embodiments, the bottom edge 102 may include a plurality of pegs, legs, a high-friction coating covering a portion or all of the bottom edge 102, and/or other supports to support and stabilize the pet steps 100 when rested on a generally flat surface. Some examples of frictional surfaces include rubber feet, roughened feet, and feet formed from a soft plastic, thermoplastic or suitable resin.

As shown in FIGS. 1A-1D, the base portion 103 may be wider than the widths W1-W4 of one or more of the steps 101. This may provide increased structural stability, for example, to prevent the pet steps 100 from wobbling or being tipped over when an animal is traversing the steps 101. In other embodiments, the base portion 103 may be the same width as the stairs or narrower than the stairs. Further, in some embodiments, the stairs may have different widths. For example, the widths W1-W4 may gradually decrease from the bottom to the top of the steps so that, e.g., the lower stairs may be wider than the higher stairs, and so on and so forth.

As shown in FIGS. 1A-1D, the base portion 103 may include a plurality of sidewalls 105 that extend upwardly from the resting surface. More particularly, the base portion 103 may include first, second, third, and forth sidewalls 105, 107, 109, 111, with the first and second sidewalls being generally parallel and opposite one another, and the third and fourth sidewalls being generally parallel and opposite one another. The sidewalls 105, 107, 109, 111 may extend vertically from the resting surface so that they are substantially perpendicular to the resting surface, and/or may extend at an angle so as to define an acute or obtuse angle with respect to the resting surface.

The third and forth sidewalls 109, 111 may each define a triangular-shaped aperture 113. As best shown in FIG. 10, the aperture 113 may define a right triangle having a hypotenuse that is substantially parallel to the gradient or pitch of the pet steps 101. The bottom leg of the triangle, i.e., adjacent the right angle, may be substantially parallel to the bottom edge 102 of the base portion 103, and the vertical leg of the triangle may be substantially parallel to the second sidewall 107. As is shown in FIG. 10, the corners of the aperture 113 may be rounded, or, in other embodiments, may be pointed. The lengths L1, L2, and H1 of the legs of the triangle may vary according to different embodiments, however, in one embodiment, the length L1 of the bottom leg may be between ¼-½ of the length L3 of the pet step 100, the length L2 of the hypotenuse may be between ¼-½ and the diagonal length L4 of the pet step 100, and the height H1 of the vertical leg of the aperture 113 may be between ¼-½ of the height H2 of the step 100.

When an animal is ascending or descending the steps 101, compressive forces associated with the weight of the animal may be substantially distributed both diagonally and vertically along the base portion 103. More particularly, the apertures 113 defined by the third and forth sidewalls 109, 111 allow for compressive forces to be distributed in a diagonal direction so that the forces are pushed diagonally outward toward the first 105 and second 107 sidewalls. This effect is similar to the distribution of compressive forces over a suspension bridge or an arch.

Accordingly, the steps 101 located further from the first 105 and second 107 sidewalls, i.e., toward the middle of the pet steps 100, are strengthened and prevented from collapsing or sagging under the weight of an animal standing above these steps 101, while allowing for a reduction in the amount of material used to form the steps due to the absence of material at the apertures 113. The life of the pet steps 100 may thus be prolonged by avoiding deformation of the material forming the steps 100. This increased ability to bear loads over the middle of the pet steps 100 also allows for the use of lighter and/or less expensive materials in the construction of the pet steps 100. Thus, the amount of material required to manufacture the pet step 100 may be reduced, for example, by using a thinner material.

While the illustrated embodiment defines a triangular-shaped aperture 113, other embodiments may define different shaped apertures, including circular, polygonal, or other shape apertures. The size of the aperture may also vary according to different embodiments of the pet step 100, however, the aperture should cover a sufficient length of the pet step 100 so that forces caused by the weight of an animal may be distributed diagonally toward the first and second sidewalls 105, 107, rather than vertically downward, particularly when the weight is applied toward the middle of the pet step 100. Similarly, the shape of the sidewalls 105, 107, 109, 111 may vary according to different embodiments of the pet step 100. For example, the sidewalls may be curved, flat, textured, and so on and so forth. As shown in FIGS. 1A-1B, for example, the third and forth sidewalls 109, 111 may curve outward around the aperture 113. In other embodiments, one or more of the sidewalls 105, 107, 109, 111 may be concave, rather than convex.

The pet steps 100 may be formed from a polymer or other suitable material. For example, the pet steps 100 may be formed of a styrene, a polypropylene, a polyvinyl chloride (“PVC”), or a polyethylene terephthalate (“PET”), among other materials. In other embodiments, the pet steps 100 may be formed from other materials, including, but not limited to, foam, cardboard, metal, wood, and so on and so forth. Additionally, in some embodiments, the surfaces of the individual steps 101 may be covered with a soft surface so as to entice an animal to traverse the steps. Similarly, the surfaces of the individual steps 101 may be covered with a high-friction material to prevent an animal from slipping off the steps. Some examples of frictional surfaces include rubber feet, roughened feet, and feet formed from a soft plastic, thermoplastic or suitable resin.

The height H2 and length L3 of the pet steps 100 may vary according to different embodiments. For example, the pet steps may be between 2.5-5 feet tall and between 2.5-5 feet wide, or may have a different height and/or length The width of the pet steps 100 may also vary according to different embodiments. In one embodiment, the pet steps 100 may be between 1-3 feet wide, or may be narrower or wider. Similarly, the number and height of the individual steps 101 may be varied according to different embodiments. As an example, a larger number of shorter steps may be appropriate for smaller animals, while a smaller number of larger steps may be appropriate for larger animals.

The edges of the pet steps 100 may also vary according to different embodiments. For example, as shown in FIGS. 1A-1 D, the edges of the steps may be rounded or, in other embodiments, may be hard edges. The edges defined by adjacent sidewalls of the base portion may also vary according to different embodiments to be rounded, tapered, hard, and so on.

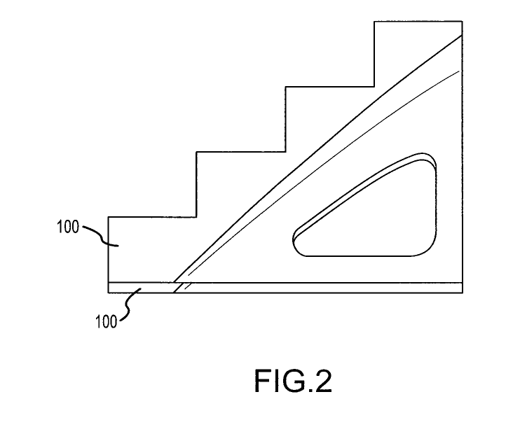

Referring to FIG. 2, multiple pet steps 100 may be stackable or nestable atop one another, allowing for compact storage of the pet steps 100 when not in use. In one embodiment, the bottom edges of the pet steps 100 may be slightly flared outward to facilitate grasping of the pet steps 100 to stack and/or remove the individual pet steps 100 from a stack. Similarly, the gradually decreasing widths W1-W4, i.e., from the bottom to the top of the steps 101, may further facilitate stacking of the pet steps 100 atop one another.

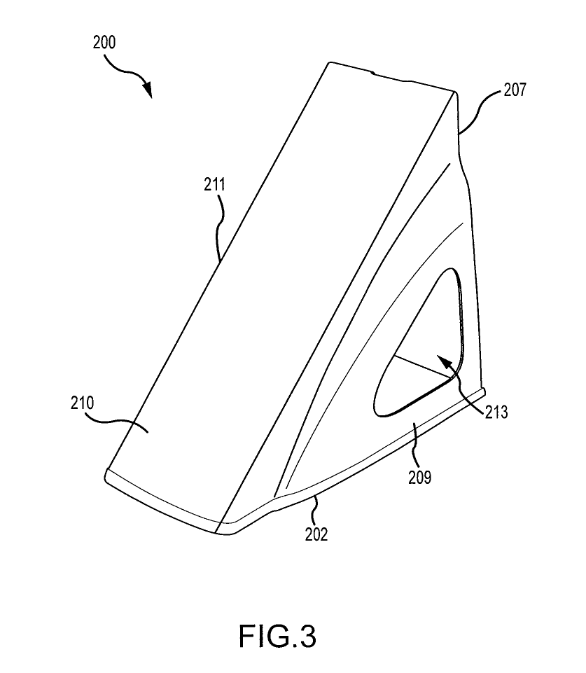

In another embodiment, shown in FIG. 3, a similar base portion 203 as used in conjunction with the pet steps 100 may be used in conjunction with a pet ramp 200. The base portion 203 may include a bottom edge 202 that is configured to contact the resting surface. The base portion 203 may further include multiple sidewalls, including first 209, second 211, and third sidewalls 207 that extend upwardly from the resting surface. Similar to the embodiment shown in FIGS. 1A-1D, the first and second sidewalls 209, 211 may be substantially parallel to and opposite one another, and may each define a triangular-shaped aperture 213.

As shown in FIG. 3, the aperture 213 may define a right triangle having a hypotenuse that is substantially parallel to the gradient or pitch of the pet steps 101. The bottom leg of the triangle, i.e., adjacent the right angle, may be substantially parallel to the bottom edge 202 of the base portion 203, and the vertical leg of the triangle may be substantially parallel to the third sidewall 207. Other embodiments may have different aperture configurations. For example, the aperture may define a non-right triangle, or may be circular or polygonal.

The pet ramp 200 may include a substantially flat ramp surface 210 that is sloped at a gradient with respect to the resting surface. When an animal is ascending or descending the ramp, the forces associated with the weight of the animal may be substantially distributed by the base portion 203 in vertical and diagonal directions. In particular, forces impacting on the pet ramp 200 when the animal is in the middle of the ramp 200 are pushed diagonally outward toward the third wall 207, which further counteracts the weight of the animal. Accordingly, the ramp 200 is prevented from sagging or collapsing under the weight of an animal.

The gradient of the ramp surface 210 may vary according to different embodiments. For example, a steeper gradient may be more suitable for a larger animal, while a smaller gradient may be more suitable for a smaller animal. The height, length, and width of the pet ramp 200 may be similar to that of the pet step 100 described in FIGS. 1A-1D, or may vary with respect to different embodiments. For example, the ramp surface 210 may be wider at the base of the ramp 200 and narrower that the top of the ramp 200, and so on and so forth.

The pet ramp 200 may be formed from a polymer or other suitable material. For example, the pet ramp 200 may be formed of a styrene, a polypropylene, PVC, or PET, among other materials. In other embodiments, the ramp 200 may be formed from other materials, including, but not limited to, foam, cardboard, metal, wood, and so on and so forth. Additionally, in some embodiments, the ramp surface 210 may be covered with a soft surface so as to entice an animal to traverse the ramp 200. Similarly, the surfaces of the individual steps 200 may be covered with a high-friction material to prevent an animal from slipping off the ramp. Some examples of frictional surfaces include rubber feet, roughened feet, and feet formed from a soft plastic, thermoplastic or suitable resin.

Similar to the pet steps 100 shown in FIGS. 1A-1D, multiple pet ramps 200 may be stackable or nestable atop one another, allowing for compact storage of the pet ramps 200 when not in use. In one embodiment, the bottom edges of the pet ramp 200 may be slightly flared outward to facilitate grasping of the pet ramp 200 to stack and/or remove the individual pet ramps 200 from a stack.

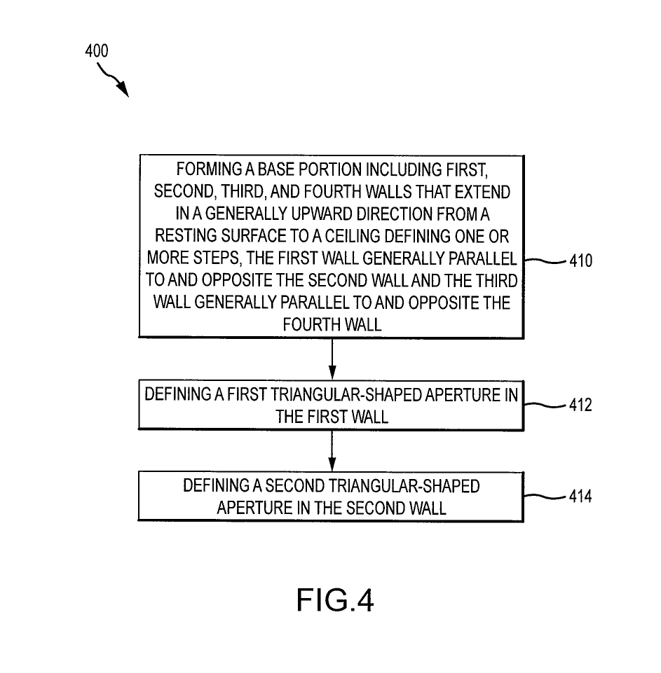

As shown in FIG. 4, another embodiment of the present invention may take the form of a method 400 of manufacturing a pet step. The method 400 includes forming a pet step base including a first wall, a second wall, a third wall, and a fourth wall that extend in a generally upward direction from a resting surface at operation 410 to a ceiling, which may define one or more steps. The first wall is generally parallel to and opposite the second wall and the third wall is generally parallel to and opposite the fourth wall. Operation 412 may include defining a first triangular-shaped aperture in the first wall, and operation 414 may include defining a second triangular-shaped aperture in the second wall. In some embodiments, the first and second apertures may be substantially identical. Additionally, the first and second apertures may each define a right triangle. In some embodiments, the hypotenuse of the right triangle may be generally parallel to a gradient of the steps.

Various changes and modifications may be made in carrying out the embodiments disclosed herein. Insofar as these changes and modifications are within the purview of the appended claims, they are to be considered as part of the disclosed embodiments. In this regard, it is to be understood that the particular configurations of the pet step are disclosed herein merely as examples of pet step configurations.

What is claimed is:

1. A pet step comprising:
one or more steps;
a base portion configured to rest on a surface and support the one or more steps, the base portion including first, second, third, and fourth sidewalls;
wherein the first sidewall defines a first triangular-shaped aperture.

2. The pet step of claim 1, wherein the first sidewall is opposite the second sidewall and the third sidewall is opposite the fourth sidewall, and the second sidewall defines a second triangular-shaped aperture.

3. The pet step of claim 2, wherein the first aperture is substantially identical to the second aperture.

4. The pet step of claim 2, wherein the first aperture defines a first right triangle and the second aperture defines a second right triangle.

5. The pet step of claim 4, wherein the a hypotenuse of the first right triangle is substantially parallel to a gradient of the one or more steps.

6. The pet step of claim 5, wherein a hypotenuse of the second right triangle is substantially parallel to a gradient of the one or more steps.

7. The pet step of claim 5, wherein a first leg of the first right triangle is substantially parallel to the fourth sidewall.

8. The pet step of claim 7, wherein a second leg of the first right triangle is substantially parallel to a bottom edge of the base portion.

9. The pet step of claim 1, wherein compressive forces exerted on the one or more steps is distributed in a diagonal direction.

10. A pet step configured to rest on a surface, comprising:
one or more steps having gradually decreasing widths from a bottom end to a top end of the pet step;
a base portion configured to rest on the surface and support the one or more steps, the base portion including first, second, third, and fourth sidewalls, the first sidewall generally parallel to and opposite the second sidewall, and the third sidewall generally parallel to and opposite the forth sidewall;
wherein the base portion has a width that is larger than at least one of the widths of the one or more steps, and is configured to distribute compressive forces exerted on the one or more steps in a diagonal direction.

11. The pet step of claim 10, wherein the first sidewall defines a first aperture and the second sidewall defines a second aperture.

12. The pet step of claim 11, wherein a the first aperture defines a first triangle and the second sidewall defines a second triangle.

13. The pet step of claim 12, wherein the first and second triangles are right triangles.

14. The pet step of claim 13, wherein a hypotenuse of the first right triangle is substantially parallel to a gradient of the one or more steps and a length of the hypotenuse is between ¼-½ of a diagonal length of the pet step.

15. The pet step of claim 14, wherein a first leg of the first right triangle is substantially parallel to the fourth sidewall and a length of the first leg is between ¼-½ of a length of the fourth sidewall.

16. The pet step of claim 15, wherein a second leg of the first right triangle is substantially parallel to a bottom edge of the base portion and a length of the second leg is between ¼-½ of a length of the bottom edge of the base portion.

17. A method for manufacturing a pet step, comprising:
forming a base portion including first, second, third, and fourth walls that extend in a generally upward direction from a resting surface to a ceiling defining one or more steps, the first wall generally parallel to and opposite the second wall and the third wall generally parallel to and opposite the fourth wall;
defining a first triangular-shaped aperture in the first wall; and
defining a second triangular-shaped aperture in the second wall.

18. The method of claim 17, wherein the first triangular-shaped aperture defines a right triangle.

19. The method of claim 18, wherein a hypotenuse of the right triangle is parallel to a gradient of the one or more steps.

20. The method of claim 17, wherein the second triangular-shaped aperture defines a right triangle.
